(19) United States
(12) Patent Application Publication
(10) Pub. No.: US 2023/0379286 A1
(43) Pub. Date: Nov. 23, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventors: Atsushi MARUYAMA, Kanagawa (JP); Koji BITO, Kanagawa (JP); Takenori MATSUO, Kanagawa (JP); Yohei UCHIUMI, Kanagawa (JP); Yoshihito SUEZAWA, Kanagawa (JP); Kosuke KIKUSHIMA, Kanagawa (JP); Kosuke ICHIKAWA, Kanagawa (JP)

(73) Assignee: FUJIFILM Business Innovation Corp., Tokyo (JP)

(21) Appl. No.: 17/969,669

(22) Filed: Oct. 19, 2022

(30) Foreign Application Priority Data
May 23, 2022 (JP) 2022-084012

(51) Int. Cl. H04L 51/52; H04L 51/10; G06V 30/416

(52) U.S. Cl. CPC H04L 51/52; H04L 51/10; G06V 30/416

(57) ABSTRACT

An information processing apparatus includes a processor configured to extract at least one information of a conversation performed or a document used in an existing group, which is associated with a new group, from among pieces of information related to the existing group in a case where the new group is created in a message exchange service for exchanging a message between plural users for each group and perform control such that the extracted information is displayed to be selectable as a candidate for information viewable by a user of the new group.

### CROSS-REFERENCE TO RELATED APPLICATIONS

This application is based on and claims priority under 35 USC 119 from Japanese Patent Application No. 2022-084012 filed May 23, 2022.

### BACKGROUND

### (i) Technical Field

The present disclosure relates to an information processing apparatus, a non-transitory computer readable medium storing an information processing program, and an information processing method.

### (ii) Related Art

For example, JP2019-207630A describes an information processing apparatus capable of generating another talk group including at least a part of a plurality of users from a talk group including a plurality of users. This information processing apparatus includes generation means for generating, from a first talk group including a first user group, a second talk group including one or more users of the first user group and including a second user group different from the first user group in a service for exchanging message talks among a plurality of users and giving means for giving an access authority within a predetermined range for the message talks in the first talk group to users constituting the second user group in a case where the second talk group is generated.

JP2002-140323A describes an information management method for managing shared information shared among a plurality of users via a network and performing information exchange on this shared information among the plurality of users. In this information management method, a history of a discussion in which each user of a plurality of terminal devices connected to the network registers a comment presented to members of the user group, as members of at least one user group among a plurality of user groups that discuss a specific topic via the network and another member registers a comment for the comment and a document registered in association with the registered comment are managed for each user group, and the comment and the document are present in accordance with a request from the user. In this information management method, the comment and the document registered in the user group are presented to the members of the user group, a document set to be presentable to users other than the members of the user group in advance is presented to users other than the members of the user group, and a user group in which a content of the comment or a comment and a document most similar to the comment and the content of the document associated with the comment are registered as a registration destination of the comment is searched and presented in accordance with a request from the user.

JP2020-052439A describes an information processing system capable of more smoothly performing message exchange as compared with a case where a person who participates earlier does not describe a situation for person who participates later or actively describes the situation in a place to exchange information using a message exchange service. This information processing system includes monitoring means for monitoring a participation state of members of a group sharing messages in a message exchange service, and dialogue control means for performing dialogue control of a virtual character such that, in a case where the monitoring means checks the participation of a first user who does not participate in a message exchange within a group or detects a sign of participation, exchange information related to message exchange already performed in the group is provided to the first user through a dialogue between the virtual character and the first user or a second user who is a member of the group.

### SUMMARY

Incidentally, in a message exchange service in which messages are exchanged among a plurality of users in each group, in a case where a new group is created, there may be an attempt to incorporate existing information (conversation contents, documents, or the like) exchanged in existing groups.

However, the existing information (conversation contents, documents, or the like) may include information that is not associated with the members of the new group. Thus, the user needs to check all conversations performed and documents used in the existing group, determine whether or not the information is associated with a new group, and select the associated information as information viewable by a user of the new group.

Aspects of non-limiting embodiments of the present disclosure relate to an information processing apparatus, a non-transitory computer readable medium storing an information processing program, and an information processing method that can reduce a load of a checking work by a user as compared with a case where a user checks all conversations performed and documents used in an existing group, determines whether or not information is associated with a new group, and selects the associated information as information viewable by a user of the new group.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to extract at least one information of a conversation performed or a document used in an existing group, which is associated with a new group, from among pieces of information related to the existing group in a case where the new group is created in a message exchange service for exchanging a message between a plurality of users for each group and perform control such that the extracted information is displayed to be selectable as a candidate for information viewable by a user of the new group.

### BRIEF DESCRIPTION OF THE DRAWINGS

Exemplary embodiment(s) of the present invention will be described in detail based on the following figures, wherein:

FIG. 1 is a diagram illustrating an example of a configuration of a message exchange service providing system according to a first exemplary embodiment;

FIG. 2 is a block diagram illustrating an example of an electrical configuration of a server device according to the first exemplary embodiment;

FIG. 3 is a block diagram illustrating an example of an electrical configuration of a terminal device according to the first exemplary embodiment;

FIG. 4 is a block diagram illustrating an example of a functional configuration of a server device according to the first exemplary embodiment;

FIG. 5 is a diagram illustrating an example of an existing group DB according to the exemplary embodiment;

FIG. 6 is a front view illustrating an example of a chat group creation screen according to the exemplary embodiment;

FIG. 7 is a front view illustrating an example of a new chat screen according to the exemplary embodiment;

FIG. 8 is a front view illustrating another example of a new chat screen according to the exemplary embodiment;

FIG. 9 is a front view illustrating still another example of the new chat screen according to the exemplary embodiment;

FIG. 10 is a front view illustrating still another example of the new chat screen according to the exemplary embodiment;

FIG. 11 is a front view illustrating still another example of the new chat screen according to the exemplary embodiment;

FIG. 12 is a flowchart illustrating an example of a flow of processing by a message exchange program according to the first exemplary embodiment;

FIG. 13 is a flowchart illustrating an example of a flow of processing by the message exchange program according to the first exemplary embodiment, and is a continuation of the flowchart of FIG. 12; and

FIG. 14 is a flowchart illustrating an example of a flow of processing by a message exchange program according to a second exemplary embodiment.

### DETAILED DESCRIPTION

Hereinafter, an example of a mode for implementing the technology of the present disclosure will be described in detail with reference to the drawings. Components and processing having the same operations, actions, and functions are given the same reference signs throughout the drawings, and redundant description may be omitted as appropriate. Each drawing is only schematically illustrated to the extent that the technology of the present disclosure can be fully understood. Thus, the technology of the present disclosure is not limited only to the illustrated examples. In the present exemplary embodiment, descriptions of configurations that are not directly related to the technology of the present disclosure and well-known configurations may be omitted.

### First Exemplary Embodiment

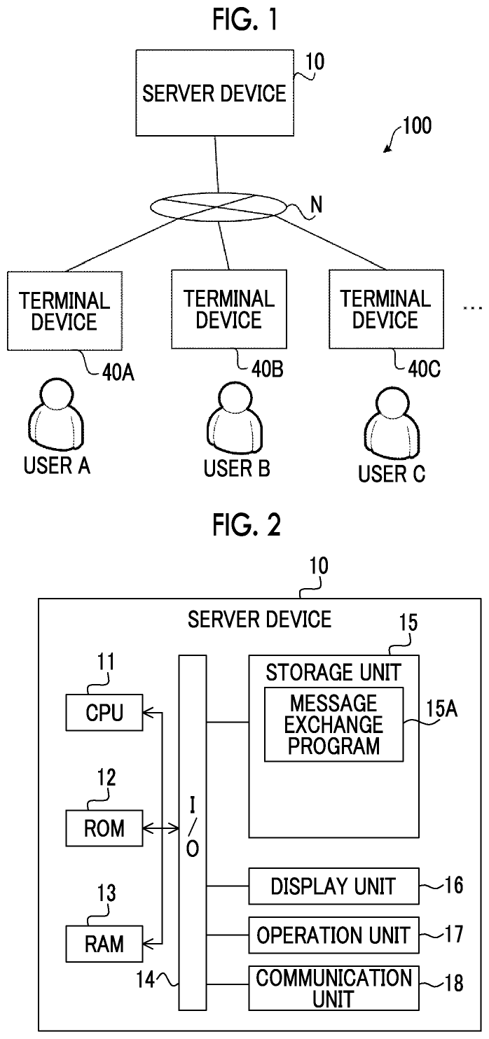

FIG. 1 is a diagram illustrating an example of a configuration of a message exchange service providing system 100 according to a first exemplary embodiment. A “message exchange service” is a service for exchanging messages between a plurality of users for each group, and includes, for example, LINE (registered trademark), Teams (registered trademark), SLACK (registered trademark), and the like.

As illustrated in FIG. 1, the message exchange service providing system 100 according to the present exemplary embodiment includes a server device 10, a terminal device 40A, a terminal device 40B, a terminal device 40C, and Although three terminal devices are illustrated in the example of FIG. 1, the number of terminal devices is any number. A user A operates the terminal device 40A, a user B operates the terminal device 40B, and a user C operates the terminal device 40C. In a case where it is not necessary to specifically distinguish and describe the plurality of terminal devices 40A, 40B, and 40C, these plurality of terminal devices 40A, 40B, and 40C may also be collectively referred to as the terminal device 40.

The terminal device 40 is a terminal device used by a user of the message exchange service, and is, for example, an information terminal such as a smart phone, a tablet terminal, or a personal computer (PC). A plurality of users operate the terminal devices 40 thereof to access the server device 10 via a network N and exchange messages with other users via the server device 10 to chat.

The server device 10 is, for example, a server computer disposed on a cloud, and provides the message exchange service. Examples of the “message exchange service” include a chat service and the like. The server device 10 is connected to a plurality of terminal devices 40 via the network N. Examples of the network N include the Internet, a local area network (LAN), a wide area network (WAN), and the like.

The server device 10 executes overall processing related to message exchange, such as message transmission and reception processing for each of the plurality of terminal devices 40 and display screen display of message transmission and reception. The server device 10 can form a group (also referred to as a chat group) of three or more users and can process message exchange within the group. Here, a message refers to data such as a text, a document, an image, and a moving image, and information can be shared by exchanging the data among a plurality of people.

FIG. 2 is a block diagram illustrating an example of an electrical configuration of the server device 10 according to the first exemplary embodiment.

As illustrated in FIG. 2, the server device 10 according to the present exemplary embodiment includes a central processing unit (CPU) 11, a read only memory (ROM) 12, a random access memory (RAM) 13, an input and output interface (I/O) 14, a storage unit 15, a display unit 16, an operation unit 17, and a communication unit 18.

The CPU 11, the ROM 12, the RAM 13, and the I/O 14 are connected via a bus. Functional units including the storage unit 15, the display unit 16, the operation unit 17 and the communication unit 18 are connected to the I/O 14. These functional units can mutually communicate with the CPU 11 via the I/O 14.

The CPU 11, the ROM 12, the RAM 13, and the I/O 14 constitute a controller. The controller may be a sub-controller that controls a part of an operation of the server device 10, or may be a part of a main controller that controls an overall operation of the server device 10. An integrated circuit such as a large scale integration (LSI) or an IC chipset is used for a part or all of blocks of the controller. An individual circuit may be used for each of the blocks, or a circuit in which a part or all of the blocks are integrated may be used. The blocks may be provided integrally, or a part of the blocks may be provided separately. In each of the blocks, a part thereof may be separately provided. A dedicated circuit or a general-purpose processor may be used for integration of the controller, and is not limited to the LSI.

Examples of the storage unit 15 include a hard disk drive (HDD), a solid state drive (SSD), a flash memory, or the like. The storage unit 15 stores a message exchange program 15A for executing the message exchange service according to the present exemplary embodiment. The message exchange program 15A may be stored in the ROM 12.

For example, the message exchange program 15A may be installed in advance in the server device 10. The message exchange program 15A may be implemented by being stored in a non-volatile storage medium or being distributed via the network N and being installed in the server device 10 as appropriate. Examples of the non-volatile storage medium include a compact disc read only memory (CD-ROM), a magneto-optical disc, a HDD, a digital versatile disc read only memory (DVD-ROM), a flash memory, a memory card, and the like.

Examples of the display unit 16 include a liquid crystal display (LCD), an organic electro luminescence (EL) display, and the like. The display unit 16 may integrally have a touch panel. Devices for operation input such as a keyboard and a mouse are provided in the operation unit 17. The display unit 16 and the operation unit 17 accept various instructions from the user of the server device 10. The display unit 16 displays various kinds of information such as results of processing executed in accordance with the instructions accepted from the user, notifications regarding the processing, and the like.

As an example, the communication unit 18 is connected to the network N such as the Internet, the LAN, or the WAN, and can communicate with each of the terminal devices 40 via the network N.

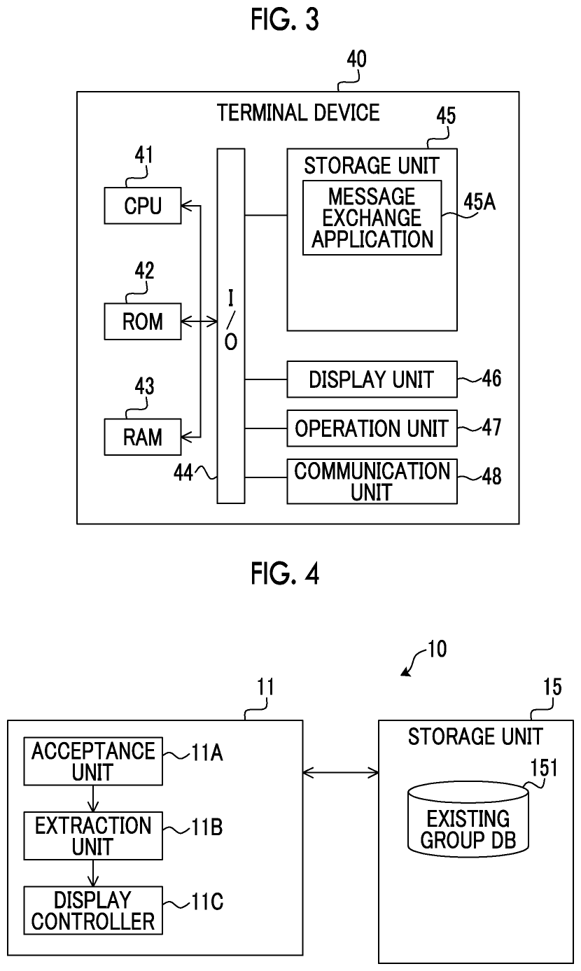

FIG. 3 is a block diagram illustrating an example of an electrical configuration of the terminal device 40 according to the first exemplary embodiment.

As illustrated in FIG. 3, the terminal device 40 according to the present exemplary embodiment includes a CPU 41, a ROM 42, a RAM 43, an I/O 44, a storage unit 45, a display unit 46, an operation unit 47, and a communication unit 48.

The CPU 41, the ROM 42, the RAM 43, and the I/O 44 are connected to each other via a bus. Functional units including the storage unit 45, the display unit 46, the operation unit 47, and the communication unit 48 are connected to the I/O 44. These functional units can mutually communicate with the CPU 41 via the I/O 44.

The CPU 41, the ROM 42, the RAM 43, and the I/O 44 constitute a controller. The controller may be a sub-controller that controls a part of an operation of the terminal device 40, or may be a part of a main controller that controls an overall operation of the terminal device 40.

Examples of the storage unit 45 include an HDD, an SSD, a flash memory, and the like. The storage unit 45 stores a message exchange application program (hereinafter, referred to as “message exchange application”) 45A that operates in cooperation with the message exchange program 15A of the server device 10. This message exchange application 45A may be stored in the ROM 42.

For example, the message exchange application 45A may be installed in advance in the terminal device 40. The message exchange application 45A may be implemented by being stored in a non-volatile storage medium or being distributed via the network N and installed in the terminal device 40 as appropriate.

Examples of the display unit 46 include a liquid crystal display (LCD), an organic EL display, and the like. The display unit 46 integrally has a touch panel. For example, buttons for operation input are provided in the operation unit 47. The display unit 46 accepts various instructions from the user of the terminal device 40. The display unit 46 displays various kinds of information such as results of processing executed in accordance with the instructions accepted from the user, notifications regarding processing, and the like.

As an example, the communication unit 48 is connected to the network N such as the Internet, the LAN, or the WAN, and can communicate with the server device 10 via the network N.

The server device 10 or the terminal device 40 is an example of an information processing apparatus, and the message exchange program 15A or the message exchange application 45A is an example of an information processing program.

Incidentally, as described above, in a case where a new group is created in the message exchange service, there may be an attempt to incorporate existing information (for example, conversation content, documents, or the like) exchanged in existing groups. However, since the existing information (for example, conversation content, documents, or the like) may include information that is not related to members of the new group, the user needs to check all conversations performed and documents used in the existing group, determine whether or not information is associated with the new group, and then select the information as information viewable by users of the new group.

By contrast, in a case where the new group is created in the message exchange service, the server device 10 according to the present exemplary embodiment extracts at least one information of the conversation performed or the document used in the existing group, which is associated with the new group, from among pieces of information on the existing group and performs control such that the extracted information is displayed to be selectable as a candidate for the information viewable by the users of the new group. Hereinafter, the “group” mentioned herein may also be referred to as a “chat group”. In the present exemplary embodiment, although the server device 10 will be described as a subject of processing, the terminal device 40 may be a subject of processing.

Specifically, the CPU 11 of the server device 10 according to the present exemplary embodiment functions as each unit illustrated in FIG. 4 by writing the message exchange program 15A stored in the storage unit 15 into the RAM 13 and executing the message exchange program. The CPU 11 is an example of a processor.

FIG. 4 is a block diagram illustrating an example of a functional configuration of the server device 10 according to the first exemplary embodiment.

As illustrated in FIG. 4, the CPU 11 of the server device 10 according to the present exemplary embodiment functions as an acceptance unit 11A, an extraction unit 11B, and a display controller 11C.

The storage unit 15 stores an existing group DB (database) 151.

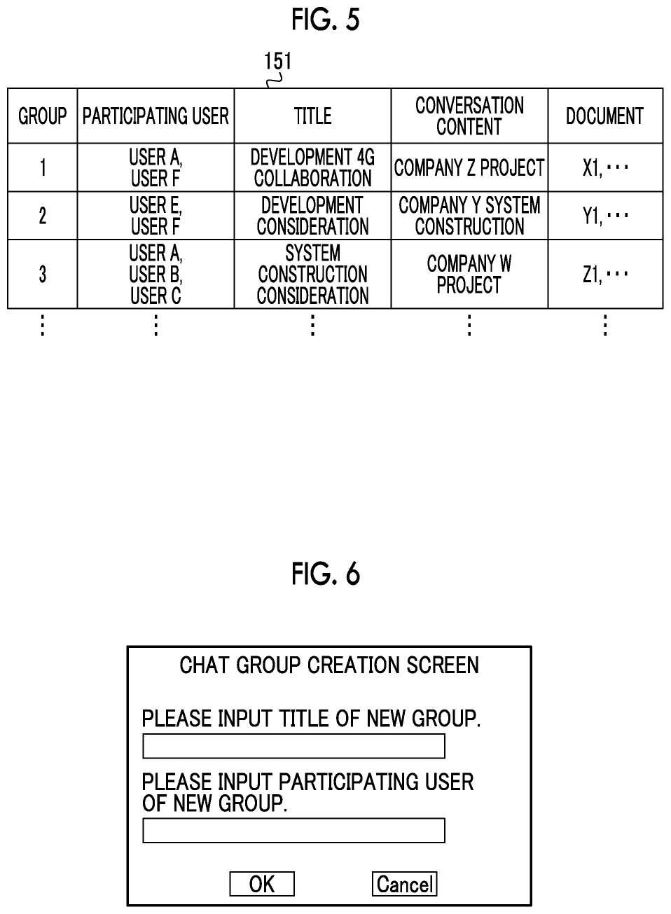

FIG. 5 is a diagram illustrating an example of the existing group DB 151 according to the present exemplary embodiment.

The existing group DB 151 illustrated in FIG. 5 stores, for each existing chat group, participating users, a title, a conversation content, and used documents in association with each other. In the example of FIG. 5, in the case of a group 1, the participating users are “user A, user F”, the title is “collaboration with development 4G”, the conversation content is “company Z project”, and the used documents are “X1, . . . ”. In the case of a group 2, the participating users are “user E, user F”, the title is “development discussion”, and the conversation content is “company Y system construction”. The used documents are “Y1, . . . ”. In the case of a group 3, the participating users are “user A, user B, user C”, the title is “system construction discussion”, the conversation content is “company W project”, and the used documents are “Z1, . . . ”.

As an example, the acceptance unit 11A displays a chat group creation screen illustrated in FIG. 6, and accepts inputs of a title and participating users related to the new group.

FIG. 6 is a front view illustrating an example of the chat group creation screen according to the present exemplary embodiment. This chat group creation screen is displayed on the display unit 46 of the terminal device 40.

In a case where there is an attempt to create a new chat group, as an example, the user of the terminal device 40 inputs a title and participating users of the new chat group from the chat group creation screen illustrated in FIG. 6.

Here, the new group is not limited to a case where a different group from the existing group is separately created, and also includes, for example, a case where new users are added to the existing group to form a new group. For example, a new group Y including users A, B, C, and D is created by deriving from an existing group X including users A, B, and C. In this case, there are the existing group X and the new group Y. On the other hand, in a case where the user D is invited to the existing group X including the users A, B, and C, the group X is a new group X including the users A, B, C, and D. In this case, since the group X including the users A, B, and C is changed to the group X including the users A, B, C, and D, it is assumed that the new group X is created.

The extraction unit 11B extracts at least one information of the conversation performed and the document used in the existing group, which is associated with the new group, (hereinafter, also referred to as “associated information”) from among the pieces of information on the existing group. Specifically, in a case where the title and the participating users related to the new group are specified, the extraction unit 11B extracts at least one information of the conversation or the used document associated with at least one of the title or the participating users related to the new group from among the pieces of information related to the existing group. For example, in a case where the title of the new group is “development 4G collaboration”, the existing group DB 151 is searched based on this “development 4G collaboration”, and at least one of the conversation or the document of the group 1 having a similar title are extracted as the associated information. In a case where “user B” is included as the participating user, the existing group DB 151 is searched based on this “user B”, and at least one of the conversation or the document of the group 3 having a similar participating user is extracted as the associated information. That is, the associated information is extracted based on at least one of a degree of matching of words (=keywords) included in the title or a matching degree of the participating user.

The display controller 11C performs control such that the associated information extracted by the extraction unit 11B is displayed to be selectable as the candidate for the information viewable by the users of the new group. For example, the associated information extracted by the extraction unit 11B is displayed on the display unit 46 of the terminal device 40. The “information viewable by the users of the new group” includes, for example, information viewable by the new group by transferring the information of the existing group as it is, and information viewable by transferring link information (URL and the like) accessible to the information of the existing group and selecting link information in the new group.

Here, in a case where the associated information is extracted, although only the title and the participating users of the new group are considered above, a new conversation of the new group may also be considered. That is, in a case where at least one of the title, the participating users, or the new conversation related to the new group is specified, the extraction unit 11B extracts, as the associated information, at least one information of the conversation or the document associated with at least one of the title, the participating users, or the new conversation related to the new group from among the pieces of information related to the existing group. In this case, the associated information is extracted based on at least one of the degree of matching of the words (=keywords) included in the title and the conversation and the degree of matching of the participating users. For example, the associated information is automatically extracted at a predesignated timing and is displayed in a selectable state as the candidate for the information viewable by the users of the new group. Examples of the timing at this time include, for example, a timing at which a first conversation is created, a timing at which conversations of a predetermined number of speeches are created, or a timing at which a certain time passes after the first conversation. The associated information may be extracted at a timing designated by the user and may be displayed in a selectable state as the candidate for the information viewable by the users of the new group. Examples of the timing at this time include, for example, a timing at which a button (not illustrated) for extracting the associated information is displayed and the user presses the button at an intended timing, and the like.

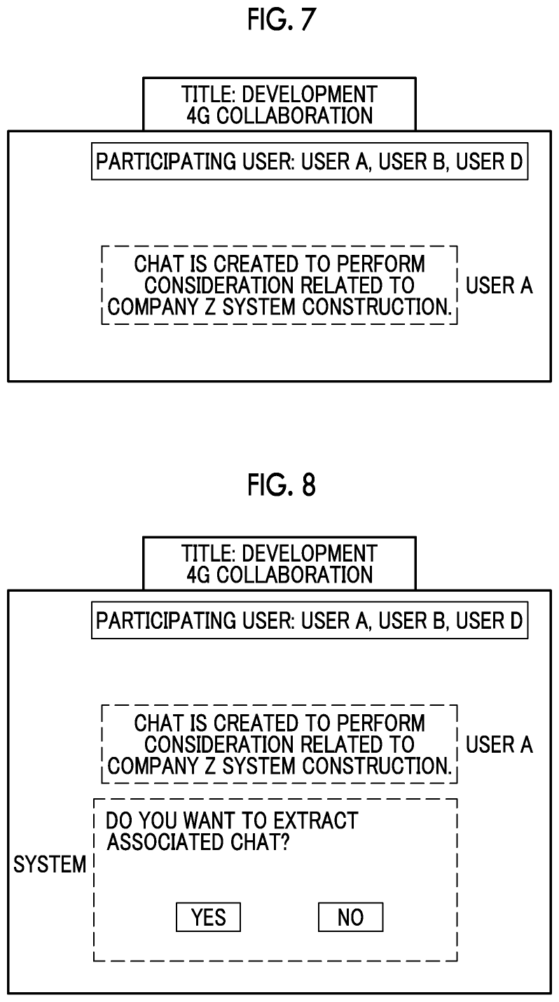

FIG. 7 is a front view illustrating an example of a new chat screen according to the present exemplary embodiment. This chat screen is displayed on the display unit 46 of the terminal device 40.

The chat screen illustrated in FIG. 7 is a chat screen of a new group in which the title is “development 4G collaboration” and the participating users are “user A, user B, user D”. Here, “I created a chat to discuss a system construction of company Z.” is created as a new conversation of the user A, and the screen transitions to a chat screen illustrated in FIG. 8.

FIG. 8 is a front view illustrating another example of the new chat screen according to the present exemplary embodiment. The chat screen illustrated in FIG. 8 is a screen transitioning from the chat screen illustrated in FIG. 7.

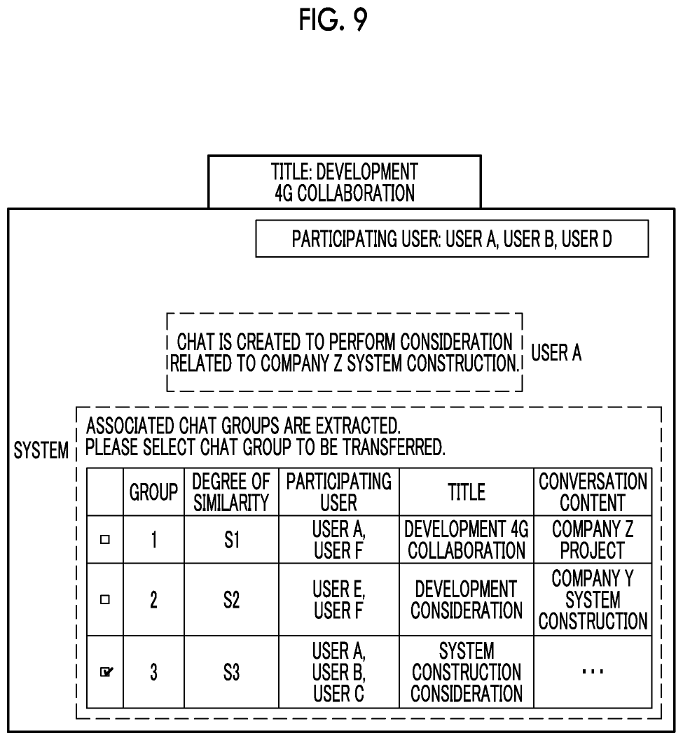

On the chat screen illustrated in FIG. 8, a message of “do you like to extract associated chats?” is automatically created on the system side. In a case where a “yes” button is selected, the screen transitions to a chat screen illustrated in FIG. 9, and in a case where a “no” button is selected, the related chats are not extracted. The display of the message may be skipped, and the chat screen illustrated in FIG. 7 may transition to the chat screen illustrated in FIG. 9.

FIG. 9 is a front view illustrating still another example of the new chat screen according to the present exemplary embodiment. The chat screen illustrated in FIG. 9 is a screen transitioning from the chat screen illustrated in FIG. 8.

The extraction unit 11B extracts the existing group associated with the information related to the new group (for example, the title, the participating users, and the conversation, or the title and the participating users) from the existing group DB 151, and derives a degree of similarity for the extracted existing group. The degree of similarity mentioned herein is a degree of similarity between the information related to the new group and the information related to the existing group. The degree of similarity is derived from at least one information of the title, the participating users, or the conversation related to the group. Although a method for deriving the degree of similarity is not particularly limited, for example, there is a method for increasing the degree of similarity as the degree of matching of the words (=keywords) in each of the participating users, the title, and the conversation is increased. Specifically, in the case of the new group, although “user A” is included in the participating users, “development 4G collaboration” is included in the title, and “company Z project” is included in the conversation, the words “user A”, “development 4G collaboration” and “company Z project” are also included in the participating users, the title, and the conversation of the existing group 1. Accordingly, a degree of similarity S1 of the existing group 1 is higher than a degree of similarity S2 of the existing group 2 and a degree of similarity S3 of the existing group 3.

In this case, as an example, the display controller 11C performs control such that candidates for the existing group are displayed to be selectable in order of degrees of similarity between the information related to the new group and the information related to the existing group, as illustrated in FIG. 9. In the example of FIG. 9, the groups 1, 2, and 3 are displayed as the candidates for the existing group, and the degree of similarity, the participating users, the title, and the conversation content are displayed for each of the groups 1, 2, and 3. In a case where the number of candidates for the existing group is too large to be displayed on the screen, a scroll bar (not illustrated) may be displayed to enable scrolling of the screen. Although all the candidates for the existing group may be displayed, even though candidates with low degrees of similarity are excluded, since it is considered that there is no large influence, for example, it is desired to selectively display only a group in which a degree of similarity is equal to or greater than a threshold value.

On the chat screen illustrated in FIG. 9, a message of “associated chat groups are extracted. please select a chat group to be transferred.” is automatically created and displayed together with the candidates for the existing group extracted on the system side. Check boxes indicated by “Q” are provided in selection fields (left fields) corresponding to the groups. In a case where the user selects any one of the check boxes by checking, the selected group is a transfer target. In the example of FIG. 9, “group 3” is the transfer target. In the example of FIG. 9, although the group to be transferred is selected by the user, a group with a highest degree of similarity or a group with a certain degree of similarity or more may be automatically selected.

As an example, the extraction unit 11B extracts at least one information of the conversation or the document associated with the new group from among the pieces of information related to the selected group based on at least one of the content of the conversation performed or a viewing history of the document used in the group selected from among the candidates for the existing group illustrated in FIG. 9. Specifically, the viewing history of the document includes at least one of a viewing time, the number of times of viewing, or the number of viewed pages of the document, and is managed by the existing group DB 151. As an example, the extraction unit 11B extracts at least one information of the conversation or the document associated with the new group from among the pieces of information related to the selected group by using a total value obtained by adding at least one of the viewing time, the number of times of viewing, or the number of viewed pages of the document obtained for each participating user of the group selected from among the candidates for the existing group illustrated in FIG. 9 for all the participating users of the selected group. The viewing time, the number of times of viewing, and the number of viewed pages of the document do not necessarily may not be actual numerical values, and may be managed by parameters corresponding to the actual numerical values. For example, a parameter “1” is associated in a case where the viewing time is less than 30 minutes, and a parameter “2” is associated in a case where the viewing time is equal to or greater than 30 minutes and is less than 1 hour.

In a case where at least one information of the conversation or the document associated with the new group is extracted, the present disclosure is not limited to the above total value, and for example, information having the largest number of times of viewing (or the number of times of editing) may be extracted.

As an example, the extraction unit 11B may perform weighting on at least one of the viewing time, the number of times of viewing, or the number of viewed pages of the document based on features of each participating user of the group selected from among the candidates for the existing group illustrated in FIG. 9. For example, an owner of the group, a person in charge of a work in the conversation, and the like are considered as an example of the features of each participating user. Specifically, in a case where the participating user is the owner of the group or the person in charge of the work in the conversation, there is a method for multiplying at least one of the viewing time, the number of times of viewing, or the number of viewed pages of the document by a predetermined weighting factor (for example, 1.1 or the like), a method for increasing the parameter by one, or the like. The features of each participating user may be managed in the existing group DB 151.

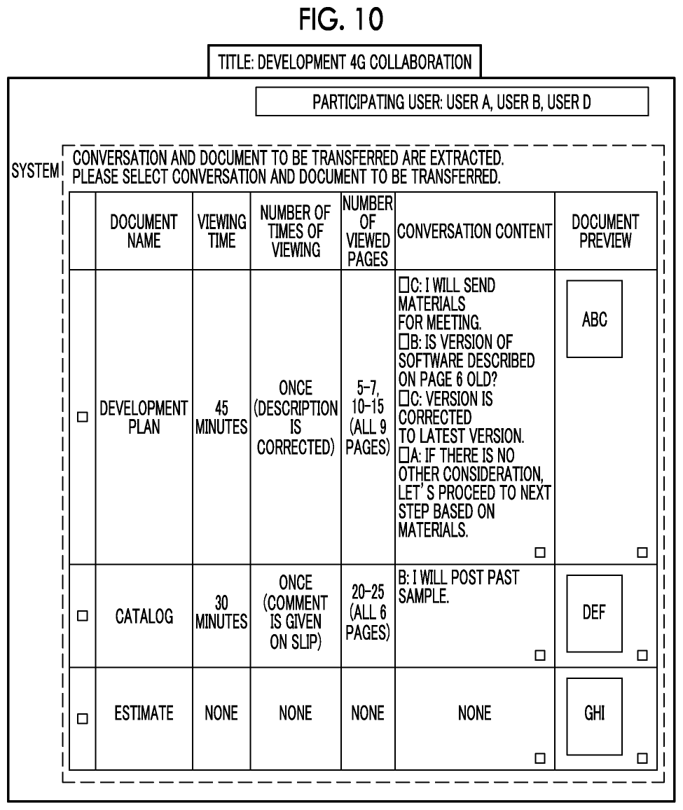

As an example, as illustrated in FIG. 10, the display controller 11C performs control such that information on the conversation and the document associated with the new group extracted by the extraction unit 11B is displayed to be selectable in association with the conversation and the document. Here, a correspondence between the document and the conversation content is performed by determining that a conversation near the conversation in which the document is operated is related. For example, conversations for a certain period before and after the document is operated, a certain number of times of conversations before and after the document is operated, or the like are associated. Information to be displayed is not limited to both the conversation and the document associated with the new group, and may be any one of the conversation or the document.

FIG. 10 is a front view illustrating still another example of the new chat screen according to the present exemplary embodiment. The chat screen illustrated in FIG. 10 is a screen transitioning from the chat screen illustrated in FIG. 9.

In the example of FIG. 10, “development plan”, “catalog”, and “estimate” are displayed as the documents associated with the new group, and the viewing time, the number of times of viewing, the number of viewed pages, the conversation content, and document previews are displayed in descending order of total values. As described above, the total value is a value obtained by adding up the viewing times, the number of times of viewing, and the number of viewed pages of the document for each participating user. The display order of the associated documents is not limited to the descending order of the total values, and may be displayed randomly. In a case where the number of associated documents is too large to be displayed on the screen, a scroll bar (not illustrated) may be displayed to enable scrolling of the screen. Although all the associated documents may be displayed, even though candidates with low total values are excluded, since it is considered that there is no large influence, only related documents with total values exceeding a threshold value may be selectively displayed.

On the chat screen illustrated in FIG. 10, a message of “a conversation and a document to be transferred are extracted. please select the conversation and the document to be transferred.” is automatically created and displayed together with information on the conversation and the document related to the new group extracted on the system side. Check boxes indicated by “Q” are provided in selection fields (left fields) corresponding to the conversations and the documents. Three check boxes are provided for each document and conversation. That is, check boxes indicated by “Q” are also provided for the conversation contents and the document previews. In this case, both the document and the conversation are the transfer targets in a case where the check box in the selection field (left field) is selected, only the conversation is the transfer target in a case where the check box for the conversation content is selected, and only the document is the transfer target in a case where the check box of the document preview is selected.

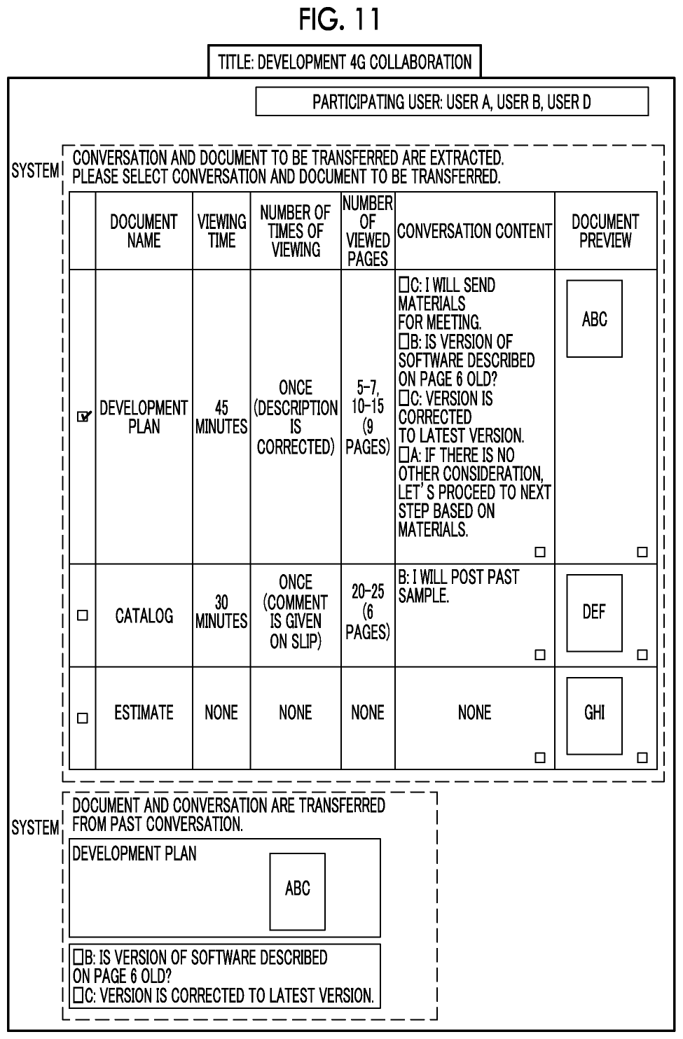

FIG. 11 illustrates a chat screen in a state where the user checks any one of the check boxes indicated by “Q”.

FIG. 11 is a front view illustrating still another example of a new chat screen according to the present exemplary embodiment. The chat screen illustrated in FIG. 11 is a screen transitioning from the chat screen illustrated in FIG. 10.

In the example of FIG. 11, the check box in the selection field (left field) of “development plan” is selected. In this case, the conversation and the document related to the “development plan” are the transfer targets. In the example of FIG. 11, although the conversation and the document to be transferred are selected by the user, the conversation and the document with highest total value or the conversation and the document of which the total value is equal to or greater than a predetermined value may be automatically selected.

As illustrated in FIG. 11, in a case where the check box in the selection field (left field) of “development plan” is selected, the selected conversation and document are transferred to the conversation in the new group. In other words, on the chat screen illustrated in FIG. 11, a message of “a document and a conversation are transferred from past conversations” is automatically created and displayed together with information on the conversation and the document transferred on the system side. At this time, the entire conversation may be transferred, or in a case where there are many conversations, only a necessary part may be selectively transferred. In the example of FIG. 11, the user selects a part of the conversation contents related to “development plan”.

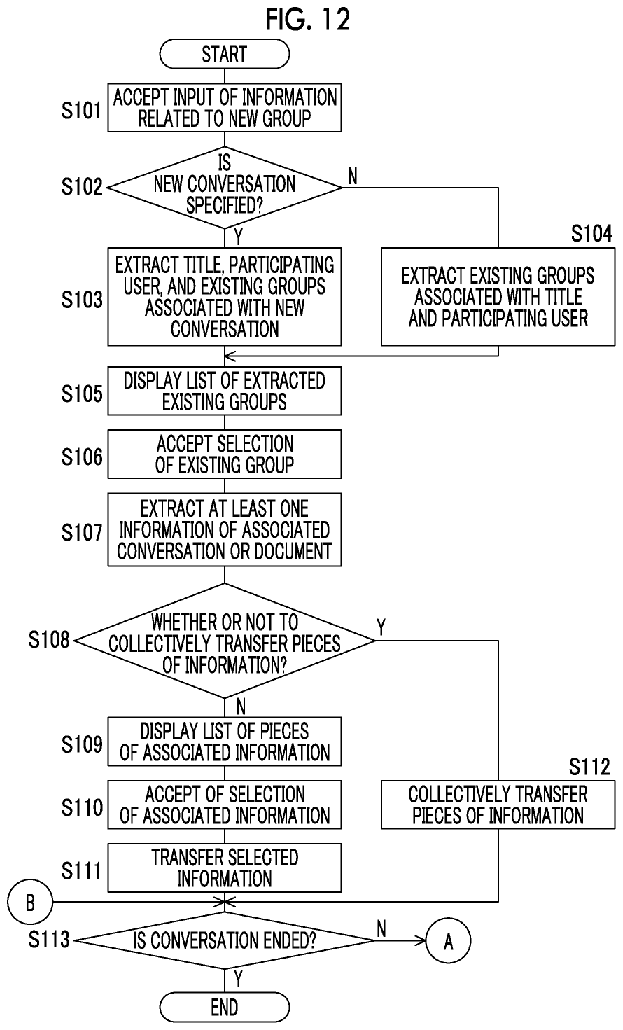

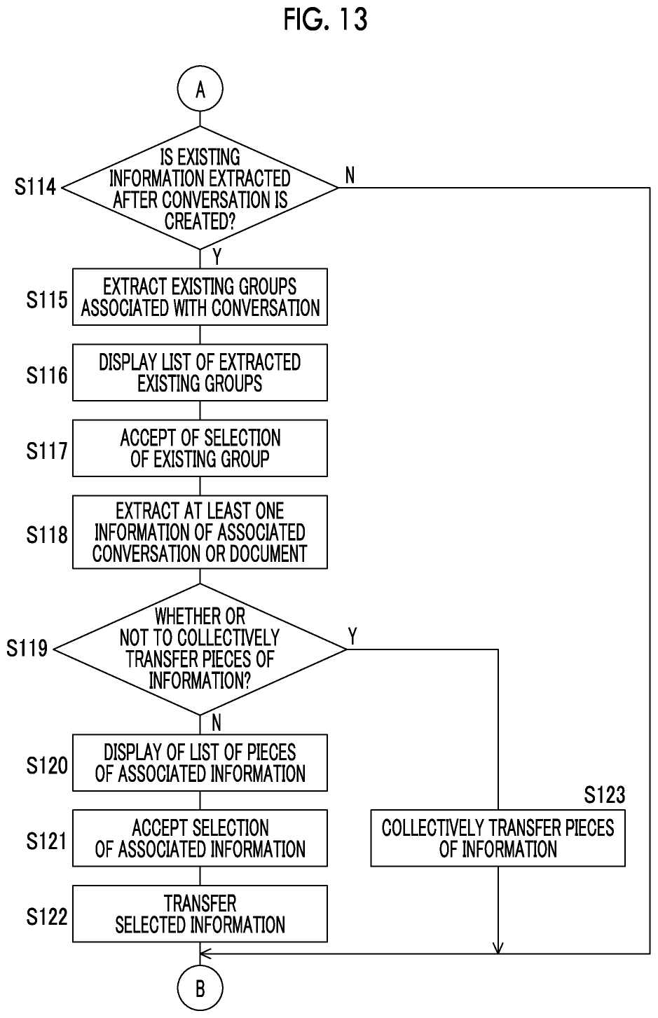

Next, an action of the server device 10 according to the first exemplary embodiment will be described with reference to FIGS. 12 and 13.

FIGS. 12 and 13 are flowcharts illustrating an example of a flow of processing by the message exchange program 15A according to the first exemplary embodiment. The flowchart in FIG. 13 is a continuation of the flowchart in FIG. 12.

First, in a case where an instruction to execute associated information transfer processing is given to the server device 10, the message exchange program 15A is activated by the CPU 11, and the following steps are executed.

In step S101 of FIG. 12, as an example, the CPU 11 displays the chat group creation screen illustrated in FIG. 6 on the display unit 46 of the terminal device 40, and accepts an input of information regarding the new group.

In step S102, the CPU 11 determines whether or not a new conversation is specified. For example, in a case where the new conversation is created on the chat screen illustrated in FIG. 7, the new conversation is specified. The CPU proceeds to step S103 in a case where it is determined that the new conversation is specified (in the case of a positive determination), and proceeds to step S104 in a case where it is determined that the new conversation is not specified (in the case of a negative determination).

In step S103, the CPU 11 extracts a title and participating users associated with the new group and existing groups related to the new conversation from the existing group DB 151.

In step S104, the CPU 11 extracts existing groups associated with the title and the participating users related to the new group from the existing group DB 151.

In step S105, as an example, the CPU 11 displays a chat screen including a list of the existing groups extracted in step S103 or step S104, as illustrated in FIG. 9.

For example, as described above, a degree of similarity between information related to the new group and information related to the existing group is derived, and existing groups of which the degree of similarity is equal to or greater than a threshold value are extracted. For example, in a case where a new group including users A, B, and C is created and a conversation is newly created, past histories are searched from the existing group DB 151 for the users A, B, and C. On the other hand, in a case where the new group including the users A, B, and C is created based on the conversation of the existing group including the users A, B, and D, the past histories are searched from the existing group DB 151 for the users A, B, C, and D. Examples of the degree of similarity include a degree of similarity between a keyword included in the title created in the new group and a content of the conversation created in the existing group. The threshold value of the degree of similarity can be designated by the system, but may be dynamically changed by machine learning whenever the system is used. The degree of similarity may be determined y using a plurality of conditions.

In step S106, the CPU 11 accepts the selection of the existing group as illustrated in FIG. 9, as an example.

In step S107, the CPU 11 extracts, as the associated information, at least one information of the conversation or the document associated with the new group from the existing group DB 151 based on at least one of the content of the conversation performed or the viewing history of the document used in the existing group for which the selection is accepted in step S106.

For example, as described above, the associated information is extracted by using the total value obtained by adding up at least one of the viewing times, the number of times of viewing, or the number of viewed pages of the document for all the participating users of the selected existing group. In addition to the viewing history (the viewing times, the number of times of viewing, or the number of viewed pages) of the document, the associated information may be extracted as relation values, an editing history (the number of times of editing and an edited content) of the document, a registration history (addition and deletion) of the document, a viewing authority of the document, and the like. A threshold value of each relation value can be designated by the system, but may be dynamically changed by machine learning whenever the system is used. The relation value may be determined by using a plurality of conditions. The correspondence between the document and the conversation content is performed by determining that a conversation near the conversation in which the document is operated is related. For example, conversations for a certain period before and after the document is operated, a certain number of times of conversations before and after the document is operated, or the like are associated.

In step S108, the CPU 11 determines whether or not to collectively transfer the pieces of associated information extracted in step S107. The CPU proceeds to step S109 in a case where it is determined not to collectively transfer the pieces of associated information (in the case of a negative determination), and proceeds to step S112 in a case where it is determined to collectively transfer the pieces of associated information (in the case of a positive determination).

In step S109, as an example, the CPU 11 displays a chat screen including a list in which the documents and the conversations extracted as the pieces of associated information in step S107 are associated with each other, as illustrated in FIG. 10. As an example, as illustrated in FIG. 10 described above, the conversation content associated with the document and the preview of the document are displayed together with a document name, and thus, the user can easily select the associated information.

In step S110, as an example, the CPU 11 accepts the selection of the associated information by the user, as illustrated in FIG. 11.

In step S111, as an example, the CPU 11 transfers the associated information for which the selection by the user is accepted to the new group, as illustrated in FIG. 11.

On the other hand, in step S112, the CPU 11 collectively transfers the pieces of associated information extracted in step S107 to the new group.

In step S113, the CPU 11 determines whether or not to end the conversation in the new group. The CPU proceeds to step S114 of FIG. 13 in a case where it is determined not to end the conversation (in the case of a negative determination), and ends the series of processing by the message exchange program 15A in a case where it is determined to end the conversation (in the case of a positive determination).

In step S114 of FIG. 13, the CPU 11 determines whether or not to extract existing information of the existing group again after the conversation of the new group is created. The CPU proceeds to step S115 in a case where it is determined to extract the existing information (in the case of a positive determination), and proceeds to step S113 of FIG. 12 in a case where it is determined not to extract the existing information (in the case of a negative determination). A timing at which the existing information is extracted again after the conversation is created can be automatically executed at regular intervals set on the system side, or may be automatically executed in a case where the number of speeches in the conversation exceeds a threshold value. An instruction to extract the existing information may be explicitly given by a button operation or the like by the user.

In step S115, the CPU 11 extracts the existing groups associated with the conversation of the new group from the existing group DB 151.

In step S116, the CPU 11 displays a chat screen including a list of the existing groups extracted in step S115.

In step S117, the CPU 11 accepts the selection of the existing group.

In step S118, the CPU 11 extracts, as the associated information, at least one information of the conversation or the document associated with the new group from the existing group DB 151 based on at least one of the content of the conversation performed or the viewing history of the document used in the existing group for which the selection is accepted in step S117.

In step S119, the CPU 11 determines whether or not to collectively transfer the pieces of associated information extracted in step S118. The CPU proceeds to step S120 in a case where it is determined not to collectively transfer the pieces of associated information (in the case of a negative determination), and proceeds to step S123 in a case where it is determined to collectively transfer the pieces of associated information (in the case of a positive determination).

In step S120, the CPU 11 displays a chat screen including a list in which the documents and the conversations extracted as the pieces of associated information are associated with each other in step S118.

In step S121, the CPU 11 accepts the selection of the associated information by the user.

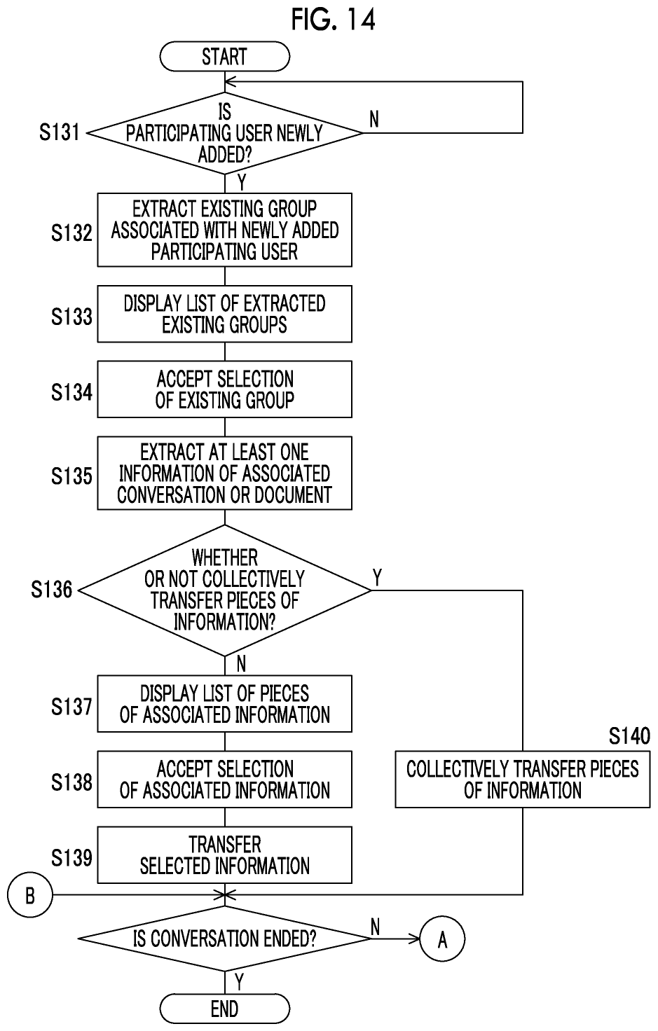

In step S122, the CPU 11 transfers the associated information of which the selection by the user is accepted to the new group, and proceeds to step S113 of FIG. 12 or step S141 of FIG. 14 to be described below.

On the other hand, in step S123, the CPU 11 collectively transfers the pieces of associated information extracted in step S118 to the new group, and proceeds to step S113 of FIG. 12 or step S114 of FIG. 14 to be described below.

Although it has been described that the server device 10 is used as the subject of processing, similar processing can be performed in a case where the terminal device 40 is used as the subject of processing.

As described above, according to the present exemplary embodiment, in a case where the new group is created, the conversation performed and the document used in the existing group are displayed in a list as the pieces of information associated with the new group. Thus, the burden of the checking work on the user is reduced compared to the case of checking all conversations and documents used in an existing group and selecting information associated with a new group.

### Second Exemplary Embodiment

In a second exemplary embodiment, a mode of extracting associated information in consideration of new participating users will be described.

A CPU 11 of a server device according to the present exemplary embodiment (hereinafter, referred to as a “server device 10A”) functions as an acceptance unit 11A, an extraction unit 11B, and a display controller 11C similarly to the server device 10 described in the first exemplary embodiment. Hereinafter, differences between the server device 10A according to the present exemplary embodiment and the server device 10 according to the first exemplary embodiment will be described.

In a case where a participating user is newly added to a specific group among existing groups to form a new group, the extraction unit 11B extracts at least one information of a conversation or a document associated with the newly added participating user of the new group from among the pieces of information on the existing groups.

For example, a user C is newly added to a specific group including users A, B, and D among all existing groups to form a new group including the users A, B, C, and D. In this case, information associated with the user C is not included in the existing conversation and document of the specific group of the users A, B, and D. Thus, information on at least one of the conversation or the document associated with the user C of the new group is extracted from the pieces of information on the existing groups. As a result, the existing information associated with the user C can be transferred to the new group.

Next, an action of the server device 10A according to the second exemplary embodiment will be described with reference to FIG. 14.

FIG. 14 is a flowchart illustrating an example of a flow of processing by the message exchange program 15A according to the second exemplary embodiment.

First, in a case where an instruction to execute associated information transfer processing is given to the server device 10A, the message exchange program 15A is activated by the CPU 11, and the following steps are executed.

In step S131 of FIG. 14, the CPU 11 determines whether or not a new participating user is added to a specific group among all existing groups. The CPU proceeds to step S132 in a case where it is determined that the participating user is newly added (in the case of a positive determination), and waits in step S131 in a case where it is determined that the participating user is not newly added (in the case of a negative determination). For example, as described above, for example, a user C is newly added to a specific group including users A, B, and D among all the existing groups to form a new group including the users A, B, C, and D.

In step S132, the CPU 11 extracts existing groups associated with the newly added participating user of the new group from the existing group DB 151. For example, the existing groups associated with the user C are extracted.

In step S133, the CPU 11 displays a chat screen including a list of the existing groups extracted in step S132.

In step S134, the CPU 11 accepts the selection of the existing group.

In step S135, the CPU 11 extracts, as the associated information, at least one information of the conversation or the document associated with the newly added participating user of the new group from the existing group DB 151 based on at least one of the content of the conversation performed or the viewing history of the document used in the existing group for which the selection is accepted in step S134. For example, at least one information of the conversation or the document associated with the user C is extracted as the associated information.

In step S136, the CPU 11 determines whether or not to collectively transfer the pieces of associated information extracted in step S135. The CPU proceeds to step S137 in a case where it is determined not to collectively transfer the associated information (in the case of a negative determination), and proceeds to step S140 in a case where it is determined to collectively transfer the pieces of associated information (in the case of a positive determination).

In step S137, the CPU 11 displays a chat screen including a list in which the documents and the conversations extracted as the pieces of associated information in step S135 are associated with each other.

In step S138, the CPU 11 accepts the selection of the associated information by the user.

In step S139, the CPU 11 transfers the associated information for which the selection is accepted by the user to the new group.

On the other hand, in step S140, the CPU 11 collectively transfers the pieces of associated information extracted in step S135 to the new group.

In step S141, the CPU 11 determines whether or not to end the conversation in the new group. The CPU proceeds to step S114 of FIG. 13 in a case where it is determined not to end the conversation (in the case of a negative determination), and ends the series of processing by this message exchange program 15A in a case where it is determined to end the conversation (in the case of a positive determination).

As described above, according to the present exemplary embodiment, in a case where the participating user is newly added to the specific group among the existing groups to form the new group, at least one information of the conversation or the document associated with the newly added participating user of the new group is extracted from among the pieces of information related to the existing group. Thus, in the new group, it is possible to transfer the existing information associated with the newly added participating user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The server device or the terminal device has been described above as the example of the information processing apparatus according to the exemplary embodiment. The exemplary embodiments may be in the form of a program for causing a computer to execute the functions of the units included in the information processing apparatus. The exemplary embodiments may be in the form of a non-transitory computer readable medium storing these programs.

The configuration of the information processing apparatus described in the above exemplary embodiments is an example, and may be changed in accordance with a situation without departing from the scope.

The flow of processing of the program described in the above exemplary embodiments is also an example, and unnecessary steps may be deleted, new steps may be added, or the processing order may be changed without departing from the scope.

In the above exemplary embodiments, although it has been described that the processing according to the exemplary embodiment is implemented by a software configuration by using a computer by executing a program, the present disclosure is not limited thereto. The exemplary embodiments may be implemented by, for example, a hardware configuration or a combination of hardware and software configurations.

The following matters are further disclosed for the above exemplary embodiments.

There is provided an information processing apparatus according to (((1))) including a processor configured to extract at least one information of a conversation performed or a document used in an existing group, which is associated with a new group, from among pieces of information related to the existing group in a case where the new group is created in a message exchange service for exchanging a message between a plurality of users for each group and perform control such that the extracted information is displayed to be selectable as a candidate for information viewable by a user of the new group.

According to an information processing apparatus according to (((2))), in the information processing apparatus according to (((1))), the processor is configured to, in a case where at least one of a title, a participating user, or a new conversation related to the new group is specified, extract at least one information of a conversation or a document associated with the at least one of the title, the participating user, or the new conversation related to the new group from among the pieces of information related to the existing group.

According to an information processing apparatus according to (((3))), in the information processing apparatus according to (((2))), the processor is configured to perform control such that the at least one information of the conversation or the document associated with the at least one of the title, the participating user, or the new conversation related to the new group is displayed to be selectable as the candidate for the information viewable by the user of the new group after the new conversation is performed and at a predesignated timing.

According to an information processing apparatus according to (((4))), in the information processing apparatus according to (((2))), the processor is configured to perform control such that the at least one information of the conversation or the document associated with the at least one of the title, the participating user, or the new conversation related to the new group is displayed to be selectable as the candidate for the information viewable by the user of the new group after the new conversation is performed and at a timing designated by the user.

According to an information processing apparatus according to (((5))), in the information processing apparatus according to any one of (((1))) to (((4))), the processor is configured to, in a case where a participating user is newly added to the existing group to form a new group, extract at least one information of a conversation or a document associated with the newly added participating user of the new group from among the pieces of information related to the existing group.

According to an information processing apparatus according to (((6))), in the information processing apparatus according to any one of (((1))) to (((5))), the processor is configured to perform control such that candidates for the existing group are displayed to be selectable in order of a degree of similarity between information related to the new group and information related to the existing group.

According to an information processing apparatus according to (((7))), in the information processing apparatus according to (((6))), the processor is configured to derive the degree of similarity from at least one information of a title, a participating user, or a conversation related to a group.

According to an information processing apparatus according to (((8))), in the information processing apparatus according to (((6))) or (((7))), the processor is configured to extract the at least one information of the conversation or the document associated with the new group from among pieces of information related to a group selected from among the candidates for the existing group based on at least one of a content of a conversation performed or a viewing history of a document used in the selected group.

According to an information processing apparatus according to (((9))), in the information processing apparatus according to (((8))), the viewing history of the document includes at least one of a viewing time, the number of times of viewing, or the number of viewed pages of the document, and the processor is configured to extract the at least one information of the conversation or the document associated with the new group from among the pieces of information related to the selected group by using a total value obtained by adding up at least one of the viewing time, the number of times of viewing, or the number of viewed pages of the document obtained for each participating user of the selected group for all participating users of the selected group.

According to an information processing apparatus according to (((10))), in the information processing apparatus according to (((9))), the processor is configured to perform weighting on at least one of the viewing time, the number of times of viewing, or the number of viewed pages of the document based on features of each participating user of the selected group.

According to an information processing apparatus related to (((11))), in the information processing apparatus related to (((9))) or (((10))), the processor is configured to perform control such that each extracted information on the conversation and the document associated with the new group is displayed to be selectable in association with the conversation and the document.

There is provided a non-transitory computer readable medium storing an information processing program according to (((12))) causing a computer to execute extracting at least one information of a conversation performed or a document used in an existing group, which is associated with a new group, from among pieces of information related to the existing group in a case where the new group is created in a message exchange service for exchanging a message between a plurality of users for each group and performing control such that the extracted information is displayed to be selectable as a candidate for information viewable by a user of the new group.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
extract at least one information of a conversation performed or a document used in an existing group, which is associated with a new group, from among pieces of information related to the existing group in a case where the new group is created in a message exchange service for exchanging a message between a plurality of users for each group; and
perform control such that the extracted information is displayed to be selectable as a candidate for information viewable by a user of the new group.

2. The information processing apparatus according to claim 1, wherein the processor is configured to:
in a case where at least one of a title, a participating user, or a new conversation related to the new group is specified,
extract at least one information of a conversation or a document associated with the at least one of the title, the participating user, or the new conversation related to the new group from among the pieces of information related to the existing group.

3. The information processing apparatus according to claim 2, wherein the processor is configured to:
perform control such that the at least one information of the conversation or the document associated with the at least one of the title, the participating user, or the new conversation related to the new group is displayed to be selectable as the candidate for the information viewable by the user of the new group after the new conversation is performed and at a predesignated timing.

4. The information processing apparatus according to claim 2, wherein the processor is configured to:
perform control such that the at least one information of the conversation or the document associated with the at least one of the title, the participating user, or the new conversation related to the new group is displayed to be selectable as the candidate for the information viewable by the user of the new group after the new conversation is performed and at a timing designated by the user.

5. The information processing apparatus according to claim 1, wherein the processor is configured to:
in a case where a participating user is newly added to the existing group to form a new group,
extract at least one information of a conversation or a document associated with the newly added participating user of the new group from among the pieces of information related to the existing group.

6. The information processing apparatus according to claim 1, wherein the processor is configured to:
perform control such that candidates for the existing group are displayed to be selectable in order of a degree of similarity between information related to the new group and information related to the existing group.

7. The information processing apparatus according to claim 6, wherein the processor is configured to:
derive the degree of similarity from at least one information of a title, a participating user, or a conversation related to a group.

8. The information processing apparatus according to claim 6, wherein the processor is configured to:
extract the at least one information of the conversation or the document associated with the new group from among pieces of information related to a group selected from among the candidates for the existing group based on at least one of a content of a conversation performed or a viewing history of a document used in the selected group.

9. The information processing apparatus according to claim 7, wherein the processor is configured to:
extract the at least one information of the conversation or the document associated with the new group from among pieces of information related to a group selected from among the candidates for the existing group based on at least one of a content of a conversation performed or a viewing history of a document used in the selected group.

10. The information processing apparatus according to claim 8, wherein the viewing history of the document includes at least one of a viewing time, the number of times of viewing, or the number of viewed pages of the document, and
the processor is configured to:
extract the at least one information of the conversation or the document associated with the new group from among the pieces of information related to the selected group by using a total value obtained by adding up at least one of the viewing time, the number of times of viewing, or the number of viewed pages of the document obtained for each participating user of the selected group for all participating users of the selected group.

11. The information processing apparatus according to claim 9, wherein the viewing history of the document includes at least one of a viewing time, the number of times of viewing, or the number of viewed pages of the document, and
the processor is configured to:
extract the at least one information of the conversation or the document associated with the new group from among the pieces of information related to the selected group by using a total value obtained by adding up at least one of the viewing time, the number of times of viewing, or the number of viewed pages of the document obtained for each participating user of the selected group for all participating users of the selected group.

12. The information processing apparatus according to claim 10, wherein the processor is configured to:
perform weighting on at least one of the viewing time, the number of times of viewing, or the number of viewed pages of the document based on features of each participating user of the selected group.

13. The information processing apparatus according to claim 11, wherein the processor is configured to:
perform weighting on at least one of the viewing time, the number of times of viewing, or the number of viewed pages of the document based on features of each participating user of the selected group.

14. The information processing apparatus according to claim 10, wherein the processor is configured to:
perform control such that each extracted information on the conversation and the document associated with the new group is displayed to be selectable in association with the conversation and the document.

15. The information processing apparatus according to claim 11, wherein the processor is configured to:
perform control such that each extracted information on the conversation and the document associated with the new group is displayed to be selectable in association with the conversation and the document.

16. A non-transitory computer readable medium storing an information processing program causing a computer to execute:
extracting at least one information of a conversation performed or a document used in an existing group, which is associated with a new group, from among pieces of information related to the existing group in a case where the new group is created in a message exchange service for exchanging a message between a plurality of users for each group; and
performing control such that the extracted information is displayed to be selectable as a candidate for information viewable by a user of the new group.

17. An information processing method comprising:
extracting at least one information of a conversation performed or a document used in an existing group, which is associated with a new group, from among pieces of information related to the existing group in a case where the new group is created in a message exchange service for exchanging a message between a plurality of users for each group; and
performing control such that the extracted information is displayed to be selectable as a candidate for information viewable by a user of the new group.
